(19) United States
(12) Patent Application Publication
(10) Pub. No.: US 2017/0254651 A1
(43) Pub. Date: Sep. 7, 2017

(54) LOCALIZATION AND MAPPING METHOD AND SYSTEM

(71) Applicant: VALEO Schalter und Sensoren GmbH, Bietigheim-Bissingen (DE)

(72) Inventor: Paulo RESENDE, Créteil (FR)

(73) Assignee: VALEO Schalter und Sensoren GmbH, Bietigheim-Bissingen (DE)

(21) Appl. No.: 15/510,374

(22) PCT Filed: Sep. 17, 2015
(86) PCT No.: PCT/EP2015/071378

§ 371 Date: Mar. 10, 2017

(30) Foreign Application Priority Data
Sep. 17, 2014 (FR) 14/02084

(51) Int. Cl. G01C 21/32; G01S 17/02; G05D 1/02; G01S 17/89

(52) U.S. Cl. CPC G01C 21/32; G01S 17/89; G01S 17/023; G05D 1/0274; G05D 1/0248

(57) ABSTRACT

The invention relates to a localisation and mapping method used by a mobile vehicle in an environment, said method comprising the following steps: the determination of the type of an object located in an area of the environment, on the basis of the data received from an on-board sensor in the mobile vehicle; and implementation of a localisation algorithm using detection data, without taking into account the detection data relating to said area or said object when the determined type is a type of mobile object.

### TECHNICAL FIELD TO WHICH THE INVENTION RELATES

The present invention relates to the localization and mapping techniques used by a mobile machine in an environment containing mobile objects.

More particularly, it relates to a localization and mapping method and a localization and mapping system for fitting to such a mobile machine.

The invention may be applied particularly advantageously in a case where certain objects present in the environment are fixed during the passage of the mobile machine equipped with the localization and mapping system, but may be moved subsequently.

### PRIOR ART

There are known localization and mapping methods used by a mobile machine (for example a robot or a motor vehicle) in an environment for the purpose of constructing a map of the environment, solely on the basis of the information delivered by one or more sensor on board the mobile machine.

Methods of this type are usually designated by the English acronym SLAM (for “Simultaneous Localization And Mapping”).

An example of a method of this type, using a visual sensor (a video camera, for example) is described in patent application WO 2004/059,900.

Localization and mapping algorithms are usually designed to map only the fixed parts of the environment, and therefore do not store the positions of objects which are mobiles during the execution of the algorithm, that is to say during the passage of the mobile machine in the proximity of these objects.

However, a problem arises in respect of objects which are fixed during the passage of the mobile machine, but may be displaced at a later time, and therefore do not really form part of the fixed environment that is to be mapped.

In particular, during a subsequent passage through the region where the moved object was located, the localization and mapping algorithm will not recognize the previously mapped environment, and will restart the map construction process, which is evidently inefficient.

### OBJECT OF THE INVENTION

In this context, the present invention proposes a localization and mapping method used by a mobile machine in an environment, comprising the following steps:
determining, on the basis of data received from a sensor on board the mobile machine, the type of an object located in an area of the environment;
executing a localization algorithm using detection data, without taking into account the detection data relating to said area or to said object if the determined type is a type of mobile object.

Thus the localization and mapping algorithm is executed on the basis of the components of the environment that are fixed in the long term. The map constructed by such a method is therefore more robust and may easily be re-used, since its component parts will all be present during a subsequent passage of the mobile machine in the same environment.

According to other characteristics, which are optional and therefore non-limiting:
the sensor is a lidar sensor;
said determination is performed by recognition of a shape or a signature in the received data;
the sensor is an image sensor;
said determination is performed by recognition of a shape in at least one image represented by the received data;
the detection data are obtained from the on-board sensor;
the detection data are obtained from another sensor, separate from said on-board sensor;
the localization algorithm uses said object as a reference point if the determined type is a fixed object type;
the localization algorithm uses the detection data relating to a given area if no object located in said given area is detected with a type corresponding to a mobile object type;
the localization algorithm that is executed constructs a map of the environment, for example by searching for a match between a version of the map being constructed and scanning data supplied by an on-board sensor and/or points of interest detected in an image supplied by an on-board sensor embedded, thereby also enabling the mobile machine to be localized on said map.

The localization and mapping method may also comprise the following steps:
saving the constructed map;
at a later time (for example on the detection of a neighboring environment resembling that which is represented in the constructed map), loading and re-using the map constructed by the localization algorithm.

The invention also proposes a localization and mapping system to be provided on a mobile machine in an environment, comprising a module for determining, on the basis of data received from a sensor on board the mobile machine, the type of an object located in an area of the environment, and a localization module designed to localize the mobile machine on the basis of detection data, without taking into account the detection data relating to said area or to said object if the determined type is a mobile object type.

The optional characteristics described above in terms of method may also be applicable to this system.

### DETAILED DESCRIPTION OF AN EXEMPLARY EMBODIMENT

The following description, referring to the attached drawings which are provided by way of non-limiting example, will make the nature and application of the invention clear.

In the attached drawings:

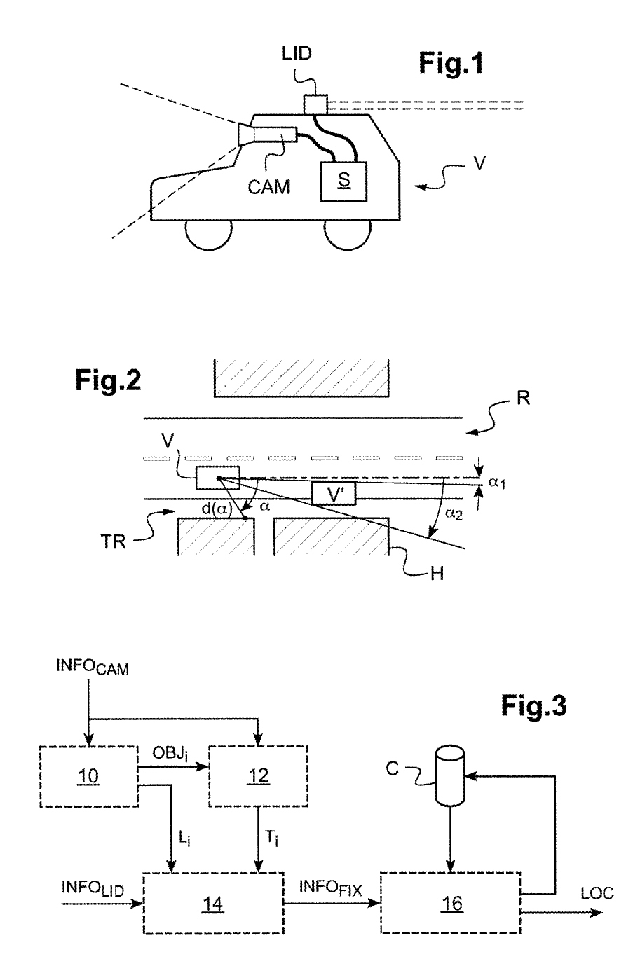

FIG. 1 shows a motor vehicle equipped with a localization and mapping system according to the invention;

FIG. 2 shows an example of a particular context that may be encountered by the vehicle of FIG. 1;

FIG. 3 shows schematically a first example of a localization and mapping system according to the invention;

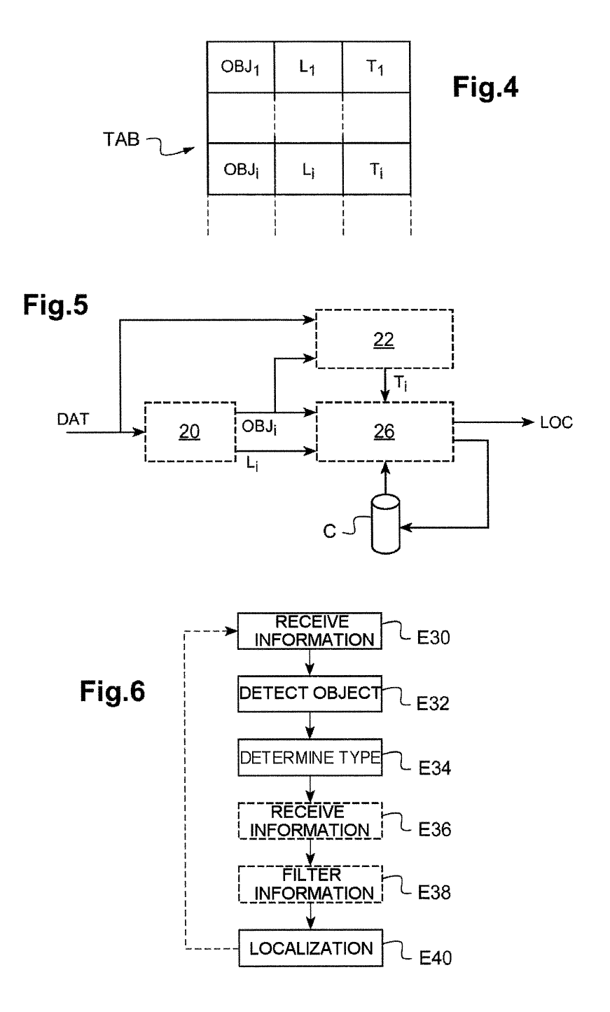

FIG. 4 shows a table of data used in the system of FIG. 3;

FIG. 5 shows schematically a second example of a localization and mapping system according to the invention; and

FIG. 6 shows the main steps of a localization and mapping method according to the invention.

FIG. 1 shows a motor vehicle V equipped with a localization and mapping system S.

In this case, the localization and mapping system S is constructed in the form of a microprocessor-based processing device.

This processing device comprises a memory (for example a read-only memory or a rewritable non-volatile memory, or any random access memory in general) adapted to store computer program instructions, the execution of which by the microprocessor of the processing device causes the execution of the methods and processes described below.

The motor vehicle V comprises one or more on-board sensors, for example a visual sensor such as a video camera CAM and/or a distance sensor such as a laser remote sensor or lidar (an acronym for “light detection and ranging”) sensor LID.

The localization and mapping system S receives the data INFO_{CAM}, INFO_{LID} generated by the on-board sensor(s), and processes them for the purposes of constructing a map C of the environment in which the motor vehicle V maneuvers and establishing the localization of the vehicle V in the constructed map C.

FIG. 2 shows an example of a context that may be encountered by the vehicle V.

In this example, the vehicle V maneuvers in a two-way road R, bordered on either side of the carriageway by a sidewalk TR, and then by houses H beyond the sidewalk TR.

A third-party vehicle V′ is parked in the part of the road R located in front of the vehicle V, partly on the carriageway of the road R and partly on the sidewalk TR.

FIG. 3 shows schematically a first example of a localization and mapping system according to the invention. In this example, the localization and mapping system S uses the data INFO_{CAM}, INFO_{LID} delivered by two sensors (in this case, the video camera CAM and the lidar sensor LID).

FIG. 3 shows functional modules, each of which corresponds to a particular process carried out by the localization and processing system S. In the example described here, the processes are carried out, as mentioned above, as a result of the execution by the microprocessor of system S of computer program instructions stored in a memory of the system S. In a variant, the processes carried out by one or more functional modules could be executed by a dedicated integrated circuit, for example an application specific integrated circuit (or ASIC).

The system of FIG. 3 comprises a detection module 10 which receives the data INFO_{CAM} generated by a first sensor, in this case the video camera CAM, and generates, for each detected object OBJᵢ, information on the localization Lᵢ of the object concerned. The localization information Lᵢ is, for example, stored in a table TAB stored in the memory of the system S, as shown schematically in FIG. 4.

In the example described here, the data INFO_{CAM} represent images successively taken by the video camera CAM; the objects OBJᵢ are detected and located with respect to the motor vehicle V by the analysis of these images, as described, for example, in patent application WO 2004/059 900, mentioned in the introduction above.

In the context of FIG. 2, the detection module 10 detects, for example, the third-party vehicle V′ as an object OBJ₁, and determines its localization (defined by the localization information L₁) with respect to the vehicle V by analysis of the images supplied by the video camera CAM.

The system of FIG. 3 also comprises a classification module 12 which receives at its input the data INFO_{CAM} generated by the first sensor (in this case the video camera CAM) and a designation of the detected objects OBJᵢ (including, for example, their position in the image received from the video camera CAM).

The classification module 12 is designed to identify the type Tᵢ of each object OBJᵢ on the basis of the data INFO_{CAM} received from the first sensor, for example, in the case described here where the data INFO_{CAM} represent an image, by means of a shape recognition algorithm.

In a variant, the first sensor could be the lidar sensor LID, in which case the identification of the type of an object OBJᵢ could be carried out, for example, on the basis of the signature of the signal received by the lidar sensor LID by reflection from the object OBJᵢ.

The identification of type Tᵢ of the objet OBJᵢ enables it to be classified among various object types (for example, vehicle, pedestrian, cyclist, house, road lighting or signaling equipment, etc.), so that it can be determined whether this object OBJᵢ is of a mobile or a fixed type. It should be noted that the classification according to the object type is performed regardless of whether the object concerned is actually fixed or mobile during the passage of the vehicle V.

For example, in the context de FIG. 2, the classification module 12 determines, by shape recognition, that the object OBJ₁ (that is to say, the third-party vehicle V′ as explained above) is of the vehicle type.

The object type Tᵢ is stored, in relation to the object concerned OBJᵢ, in the aforesaid table TAB, as shown in FIG. 4. In a variant, the stored information could be limited to an indication of the mobile or fixed nature of the object concerned OBJᵢ, this indication being determined on the basis of the type Tᵢ, identified as mentioned above.

For clarity of description, the detection module 10 and the classification module 12 have been described as two separate modules. However, it would be feasible for the detection of an object OBJᵢ and the identification of its type T, (enabling it to be classified as a mobile or fixed object) to be performed during the same step, for example by means of an algorithm for shape recognition in the images delivered by the video camera CAM.

The system S comprises a filtering module 14 which receives the data INFO_{LID} received from the second sensor, in this case the lidar sensor LID. The filtering module 14 also uses the localization L₁ of each object OBJ, detected by the detection module 10 and the type Ti of each object determined by the classification module 12 (this information may be received from the module concerned or read from the stored table TAB).

In the example described here, the data INFO_{LID} delivered by the lidar sensor represent, for example, a set of values of detection distance d(a) associated, respectively, with angles a over the whole angular range from 0° to 360°.

From among the data INFOLID, the filtering module 14 transmits only the data INFO_{FIX} which correspond to areas for which no object has been detected, or for which an object OBJᵢ has been detected with a fixed object type Tᵢ, according to the information generated by the detection and classification modules 10, 12 as described above. In other words, the filtering module 14 does not transmit the data INFO_{FIX} relating to areas for which an object OBJᵢ has been detected with a mobile object type Tᵢ.

In the context of FIG. 2, the object OBJ₁ (a third-party vehicle V′) detected with a mobile object type T₁ (vehicle) covers the angular range α₁-α₂, according to the localization information L₁, so that in the absence of any other object identified with a mobile object type, the filtering module 14 transmits only the data INFO_{FIX} associated with the angular ranges [0°, α₁ [and] α₂, 360° [(that is to say, the data representing the values of d(α) only for 0≦α<α₁ and α₂<α<360°).

The transmitted data INFO_{FIX} are received, after filtering by the filtering module 14, by a localization module 16, which uses these data INFO_{FIX} for the execution of an algorithm for simultaneous localization and mapping, such as that described in the paper “A real-time robust SLAM for large-scale outdoor environments” by J. Xie, F. Nashashibi, M. N. Parent and 0. Garcia-Favrot, in ITS World Congr. 2010.

The localization module 16 may be used, on the basis of the data INFO_{FIX} obtained from the second sensor (the lidar sensor LID in the example described), after filtering in this case, and using a map C constructed by the localization module 16 in the preceding iterations, to determine the current position (or localization) LOC of the vehicle V on the map C, and also to enrich the map C, notably as a result of the presence among the data INFO_{FIX} of data relating to areas not reached by the lidar sensor in the preceding iterations.

However, it should be noted that, owing to the rejection (by the filtering module 14) of the data INFO_{LID} relating to areas where an object OBJᵢ has been detected with a mobile object type Tᵢ, only the data relating to objects permanently present are processed by the localization module 16, thus preventing the processing of data which are actually of no use (thereby speeding up the processing), while also allowing the construction of a map containing no object that might be moved subsequently: such a map is more robust and easy to re-use.

FIG. 5 shows schematically a second example of a localization and mapping system according to the invention. In this example, the localization and mapping system S uses the data DAT delivered by a single sensor, in this case the video camera CAM.

As in FIG. 3, FIG. 5 shows functional modules, each of which corresponds to a particular process carried out by the localization and processing system S, in this case as a result of the execution, by the microprocessor of the system S, of computer program instructions stored in a memory of the system S. In a variant, the processes carried out by one or more functional modules could be executed by a dedicated integrated circuit, for example an application specific integrated circuit (or ASIC).

The system of FIG. 5 comprises a detection module 20 which receives the data DAT generated by the sensor, in this case data representative of images taken by the video camera CAM, and generates, for each object OBJᵢ that is detected (by image analysis in this case), information on the localization Lᵢ of the object concerned. The localization information Lᵢ is, for example, stored in a table TAB stored in the memory of the system S, as shown schematically in FIG. 4.

The system S of FIG. 5 comprises a classification module 22 which receives at its input the data DAT generated by the sensor (in this case the video camera CAM) and a designation of the detected objects OBJᵢ (including, for example, their position in the image received from the video camera CAM).

The classification module 12 is designed to identify the type Tᵢ of each object OBJᵢ on the basis of the data DAT received from the sensor, for example, in the case described here where the data DAT represent an image, by means of a shape recognition algorithm.

As mentioned above with reference to FIG. 3, the identification of type Tᵢ of the objet OBJᵢ enables it to be classified among various object types, so that it can be determined whether this object OBJᵢ is of a mobile or a fixed type, regardless of whether or not the object is actually fixed or mobile during the passage of the vehicle V.

The object type Tᵢ is stored, in relation to the object concerned OBJᵢ, in the aforesaid table TAB, as shown in FIG. 4. In a variant, the stored information could be limited to an indication of the mobile or fixed nature of the object type Tᵢ recognized for the object concerned OBJᵢ.

As mentioned above in relation to FIG. 3, it would be feasible, in a variant, for the detection of an object OBJᵢ and the identification of its type Tᵢ (enabling it to be classified as a mobile or fixed object) to be performed during the same processing step (that is to say, by the same functional module).

For each object detected by the detection module 20, a localization module 26 receives the description of this object OBJᵢ, its localization Lᵢ and its identified type Tᵢ, and, on the basis of this information, executes a simultaneous mapping and localization algorithm, also using a map C constructed in preceding iterations of the algorithm.

The map C includes, for example, a set of reference points (or “landmarks”, as they are known in English), each corresponding to an object detected in a preceding iteration.

The localization module 26 is designed so that the processing carried out by it takes into account only the objects OBJᵢ for which the associated type Tᵢ does not correspond to a mobile object type. For example, before taking localization information Lⱼ of an object OBJⱼ into account in the simultaneous mapping and localization algorithm, the localization module 26 checks the type Tⱼ of the object OBJⱼ (in this case by consulting the table TAB stored in the memory of the system S), and will only actually use the localization information Lⱼ in the algorithm if the type Tⱼ is a fixed object type and not a mobile object type.

On the basis of the localization information Lᵢ for objects whose type Tᵢ corresponds to a fixed object type (but without taking into account the localization information Lᵢ for objects whose type Tᵢ corresponds to a mobile object type), the localization module 26 determines the current position (or localization) LOC of the vehicle V on the map C (typically by comparing each detected object OBJᵢ with the reference points included in the map C) and enriches the map C (typically by adding to the map C the detected objects OBJᵢ which do not correspond to any reference point, so that each of them forms a new reference point in the completed map C).

As mentioned above in relation to the first example of a localization and mapping system, the constructed map C is robust and easily re-usable, since it is constructed on the basis of objects that are not subject to movement.

FIG. 6 shows the main steps of a localization and mapping method according to the invention.

This method starts with a step E30 or receiving data generated by an on-board sensor in the vehicle V, in this case the video camera CAM or the lidar sensor LID.

The method continues with a step E32 of detecting objects present in the environment in which the vehicle V maneuvers, by analyzing the data received from the on-board sensor in step E30. This step is executed, in the examples described above, by the detection module 10, 20.

The method then comprises a step E34 of determining, for each object detected in E32, and on the basis of the data received from the on-board sensor in step E30, the type of the object concerned, for example by means of a shape recognition algorithm (if the data received from the on-board sensor represent an image) or by means of a signature recognition algorithm (if the data received from the on-board sensor represent a signal). This step is executed, in the examples described above, by the classification module 12, 22.

It should be noted that it would be possible, in a variant, to use the data obtained from a plurality of sensors to classify the objects according to their type, after a step of merging the data obtained from the different sensors if necessary.

If two sensors are for the classification of the objects and for the localization of the mobile machine respectively, as in the first example given above with reference to FIG. 3, the method comprises a step E36 of receiving data generated by the second sensor.

The method may then include, if necessary, a step E38 of filtering the data received in step E36, in order to reject the data relating to the objects whose type determined in step E34 is a mobile object type, or relating to areas of the environment where an object has been detected with a type (determined in step E34) corresponding to a mobile object type. The filtering module 14 used in the first example described above with reference to FIG. 3 executes a step of this kind.

In a variant, as in the case of the second example described with reference to FIG. 5, the method does not specifically include a filtering step; in this case, the step of localization described below is designed to operate without taking into account the data relating to the objects whose type determined in step E34 is a mobile object type, or relating to areas of the environment where an object has been detected with a type (determined in step E34) corresponding to a mobile object type.

The method continues with a step E40 of localizing the mobile machine (in this case the motor vehicle V) on the basis of detection data, which may be the data received in step E30 and/or the data received in step E36 (if such a step is executed), and on the basis of a map constructed in previous iterations of the method.

This step E40 comprises the execution of a simultaneous localization and mapping algorithm, making it possible not only to localize the machine but also to enrich the map.

It should be noted that, as mentioned above, the data used by the localization and mapping algorithm may be obtained from a plurality of on-board sensors, after a step of merging the data obtained from the different sensors if necessary.

In this case, provision is usually made for the method to loop back to step E30 for the execution, at a later instant, of a new iteration of steps E30 to E40.

The map constructed during the process described above is kept permanently so that it may be re-used subsequently, for example during the passage of the mobile machine (in this case the motor vehicle V) in the environment at a later time (for example on another day, after the day on which the map was constructed).

For this purpose, the localization and mapping system S incorporates, for example, a mechanism for comparing the map being constructed with the maps previously constructed (and stored) with a view to their re-use. Thus, if the mobile machine again travels in the same environment at said later time, the comparison mechanism may be used to recognize the neighboring environment as that represented in the previously constructed map, and to use the previously constructed map (by loading this map into memory and using it in the localization and mapping algorithm).

The comparison mechanism operates particular well if the stored card has been constructed by the method described above, since a map of this kind contains only the information relating to objects which remain fixed, and contains no information relating to objects which will no longer be present during the later passage. Thus the invention provides mapping which may be used in the long term for the localization of the mobile machine.

1. A localization and mapping method used by a mobile machine in an environment, comprising:
determining, on the basis of data received from a sensor on board the mobile machine, a type of an object located in an area of the environment; and
executing a localization algorithm using detection data, without taking into account the detection data relating to said area or to said object when if the determined type is a mobile object type.

2. The method as claimed in claim 1, wherein the sensor is a lidar sensor.

3. The method as claimed in claim 2, wherein said determination is performed by recognition of a shape or a signature in the received data.

4. The method as claimed in claim 1, wherein the sensor is an image sensor.

5. The method as claimed in claim 4, wherein said determination is performed by recognition of a shape in at least one image represented by the received data.

6. The method as claimed in claim 1, wherein the detection data are obtained from the on-board sensor.

7. The method as claimed in claim 1, wherein the detection data are obtained from another sensor separate from said on-board sensor.

8. The method as claimed in claim 1, wherein the localization algorithm uses said object as a reference point if the determined type is a fixed object type.

9. The method as claimed in claim 1, wherein the localization algorithm uses the detection data relating to a given area when no object located in said given area is detected with a type corresponding to a mobile object type.

10. The method as claimed in claim 1, wherein the localization algorithm that is executed constructs a map of the environment.

11. The method as claimed in claim 10, further comprising:
saving the constructed map; and
at a later time, loading and re-using the map constructed by the localization algorithm.

12. A localization and mapping system to be fitted to a mobile machine in an environment, comprising:
a module for determining, on the basis of data received from a sensor on board the mobile machine, a type of an object located in an area of the environment; and
a localization module configured to localize the mobile machine on the basis of detection data, without taking into account the detection data relating to said area or to said object when if the determined type is a mobile object type.
